(19) United States
(12) Patent Application Publication
(10) Pub. No.: US 2025/0325901 A1
(43) Pub. Date: Oct. 23, 2025

(54) USE OF BIOMETRIC SIGNAL TO TRIGGER RECORDING OF COMPUTER GAME CLIP

(71) Applicant: Sony Interactive Entertainment Inc., Tokyo (JP)

(72) Inventors: Alex Benbassat, San Mateo, CA (US); Murshed Choudhury, San Mateo, CA (US); Zade Lobo, San Mateo, CA (US); Jorge Arroyo Palacios, San Mateo, CA (US); Maulikkumar Shah, San Mateo, CA (US); John Sweeney, San Mateo, CA (US)

(21) Appl. No.: 18/639,278

(22) Filed: Apr. 18, 2024

(51) Int. Cl. A63F 13/212; A63F 13/23

(52) U.S. Cl. CPC A63F 13/212; A63F 13/23

(57) ABSTRACT

When a gamer's sensed heart rate or other biometric indicator indicates that the gamer is excited or otherwise that an interesting part of a computer game is commanding the gamer's attention, a clip of the game is automatically recorded. A heat map of heart rate may be presented to the gamer showing the gamer his reactions as he moves around the game space. Also, a specific heart rate capture mechanism on a game controller is presented.

### FIELD

The present application relates generally to using biometric signals to trigger recording of computer game clips.

### BACKGROUND

Computer gamers from time to time enjoy recording video clips of their game play.

### SUMMARY

Present principles understand that it would be desirable to provide a means for a gamer to automatically cause a clip to be recorded using a sensed input, rather than requiring an affirmative action on the part of the gamer to commence recording.

Accordingly, a method includes identifying a heart rate of a computer gamer, and responsive to the heart rate, automatically commencing recording a computer game being played by the gamer.

The method can include commencing recording of the computer game responsive to the heart being at least as high as a first heart rate. Also, the method may include ending recording of the computer game responsive to the heart rate being less than the first heart rate.

In some embodiments, the method may include presenting, on a display on which the computer game is presented, a heat map related to the heart rate. The heat map can include a map of a virtual space which in turn may depict a player's travel path through the virtual space the segments of which may be color-coded corresponding to respective heart rates of the player as the player traversed the virtual space.

In example implementations the heart rate of the player can be identified based at least in part on a signal from at least first and second electrical components on a game controller. The first electrical component provides a reference voltage and the second electrical contact provides a pulse indication voltage. The first contact can be adjacent a portion of the controller in contact with a finger of the player and the second contact can be adjacent a palm of the player when the player holds the controller to control the game.

In another aspect, an apparatus includes a computer game controller body having controls manipulable to send signals to control a computer game. The computer game controller body also includes left and right handles grippable by left and right hands of a player and a bridge portion connecting the handles, and each handle has a distal end. A reference electrical component is adjacent at least one of the distal ends to provide a reference voltage. Also, a pulse electrical component is medially located on at least one of the handles to provide a voltage representing a pulse in a palm of a player gripping the handle.

In another aspect, a device includes at least one processor system configured to receive at least one signal from at least one pulse rate sensor, and responsive to the signal, commence recording of at least one computer simulation.

The details of the present application, both as to its structure and operation, can be best understood in reference to the accompanying drawings, in which like reference numerals refer to like parts, and in which:

### BRIEF DESCRIPTION OF THE DRAWINGS

FIG. 1 is a block diagram of an example system in accordance with present principles;

FIG. 2 illustrates example logic in example flow chart format;

FIGS. 3 and 4 illustrate example screen shots consistent with FIG. 2;

FIG. 5 illustrates an example screen shot showing various presentations of heart rate;

FIG. 6 illustrates an example heat map presented on a display consistent with the player's heart rate; and

FIG. 7-9 illustrate an example game controller with pulse sensing components.

### DETAILED DESCRIPTION

This disclosure relates generally to computer ecosystems including aspects of consumer electronics (CE) device networks such as but not limited to computer game networks. A system herein may include server and client components which may be connected over a network such that data may be exchanged between the client and server components. The client components may include one or more computing devices including game consoles such as Sony PlayStation® or a game console made by Microsoft or Nintendo or other manufacturer, extended reality (XR) headsets such as virtual reality (VR) headsets, augmented reality (AR) headsets, portable televisions (e.g., smart TVs, Internet-enabled TVs), portable computers such as laptops and tablet computers, and other mobile devices including smart phones and additional examples discussed below. These client devices may operate with a variety of operating environments. For example, some of the client computers may employ, as examples, Linux operating systems, operating systems from Microsoft, or a Unix operating system, or operating systems produced by Apple, Inc., or Google, or a Berkeley Software Distribution or Berkeley Standard Distribution (BSD) OS including descendants of BSD. These operating environments may be used to execute one or more browsing programs, such as a browser made by Microsoft or Google or Mozilla or other browser program that can access websites hosted by the Internet servers discussed below. Also, an operating environment according to present principles may be used to execute one or more computer game programs.

Servers and/or gateways may be used that may include one or more processors executing instructions that configure the servers to receive and transmit data over a network such as the Internet. Or a client and server can be connected over a local intranet or a virtual private network. A server or controller may be instantiated by a game console such as a Sony PlayStation®, a personal computer, etc.

Information may be exchanged over a network between the clients and servers. To this end and for security, servers and/or clients can include firewalls, load balancers, temporary storages, and proxies, and other network infrastructure for reliability and security. One or more servers may form an apparatus that implement methods of providing a secure community such as an online social website or gamer network to network members.

A processor may be a single- or multi-chip processor that can execute logic by means of various lines such as address lines, data lines, and control lines and registers and shift registers. A processor including a digital signal processor (DSP) may be an embodiment of circuitry. A processor system may include one or more processors.

Components included in one embodiment can be used in other embodiments in any appropriate combination. For example, any of the various components described herein and/or depicted in the Figures may be combined, interchanged, or excluded from other embodiments.

“A system having at least one of A, B, and C” (likewise “a system having at least one of A, B, or C” and “a system having at least one of A, B, C”) includes systems that have A alone, B alone, C alone, A and B together, A and C together, B and C together, and/or A, B, and C together.

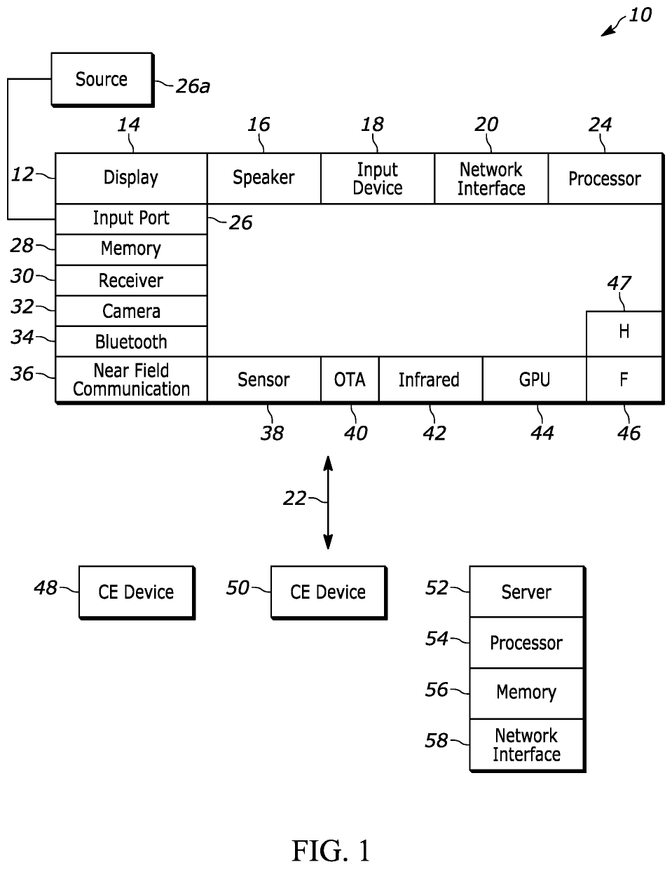

Referring now to FIG. 1, an example system 10 is shown, which may include one or more of the example devices mentioned above and described further below in accordance with present principles. The first of the example devices included in the system 10 is a consumer electronics (CE) device such as an audio video device (AVD) 12 such as but not limited to a theater display system which may be projector-based, or an Internet-enabled TV with a TV tuner (equivalently, set top box controlling a TV). The AVD 12 alternatively may also be a computerized Internet enabled (“smart”) telephone, a tablet computer, a notebook computer, a head-mounted device (HMD) and/or headset such as smart glasses or a VR headset, another wearable computerized device, a computerized Internet-enabled music player, computerized Internet-enabled headphones, a computerized Internet-enabled implantable device such as an implantable skin device, etc. Regardless, it is to be understood that the AVD 12 is configured to undertake present principles (e.g., communicate with other CE devices to undertake present principles, execute the logic described herein, and perform any other functions and/or operations described herein).

Accordingly, to undertake such principles the AVD 12 can be established by some, or all of the components shown. For example, the AVD 12 can include one or more touch-enabled displays 14 that may be implemented by a high definition or ultra-high definition “4K” or higher flat screen. The touch-enabled display(s) 14 may include, for example, a capacitive or resistive touch sensing layer with a grid of electrodes for touch sensing consistent with present principles.

The AVD 12 may also include one or more speakers 16 for outputting audio in accordance with present principles, and at least one additional input device 18 such as an audio receiver/microphone for entering audible commands to the AVD 12 to control the AVD 12. The example AVD 12 may also include one or more network interfaces 20 for communication over at least one network 22 such as the Internet, an WAN, an LAN, etc. under control of one or more processors 24. Thus, the interface 20 may be, without limitation, a Wi-Fi transceiver, which is an example of a wireless computer network interface, such as but not limited to a mesh network transceiver. It is to be understood that the processor 24 controls the AVD 12 to undertake present principles, including the other elements of the AVD 12 described herein such as controlling the display 14 to present images thereon and receiving input therefrom. Furthermore, note the network interface 20 may be a wired or wireless modem or router, or other appropriate interface such as a wireless telephony transceiver, or Wi-Fi transceiver as mentioned above, etc.

In addition to the foregoing, the AVD 12 may also include one or more input and/or output ports 26 such as a high-definition multimedia interface (HDMI) port or a universal serial bus (USB) port to physically connect to another CE device and/or a headphone port to connect headphones to the AVD 12 for presentation of audio from the AVD 12 to a user through the headphones. For example, the input port 26 may be connected via wire or wirelessly to a cable or satellite source 26a of audio video content. Thus, the source 26a may be a separate or integrated set top box, or a satellite receiver. Or the source 26a may be a game console or disk player containing content. The source 26a when implemented as a game console may include some or all of the components described below in relation to the CE device 48.

The AVD 12 may further include one or more computer memories/computer-readable storage media 28 such as disk-based or solid-state storage that are not transitory signals, in some cases embodied in the chassis of the AVD as standalone devices or as a personal video recording device (PVR) or video disk player either internal or external to the chassis of the AVD for playing back AV programs or as removable memory media or the below-described server. Also, in some embodiments, the AVD 12 can include a position or location receiver such as but not limited to a cellphone receiver, GPS receiver and/or altimeter 30 that is configured to receive geographic position information from a satellite or cellphone base station and provide the information to the processor 24 and/or determine an altitude at which the AVD 12 is disposed in conjunction with the processor 24.

Continuing the description of the AVD 12, in some embodiments the AVD 12 may include one or more cameras 32 that may be a thermal imaging camera, a digital camera such as a webcam, an IR sensor, an event-based sensor, and/or a camera integrated into the AVD 12 and controllable by the processor 24 to gather pictures/images and/or video in accordance with present principles. Also included on the AVD 12 may be a Bluetooth® transceiver 34 and other Near Field Communication (NFC) element 36 for communication with other devices using Bluetooth and/or NFC technology, respectively. An example NFC element can be a radio frequency identification (RFID) element.

Further still, the AVD 12 may include one or more auxiliary sensors 38 that provide input to the processor 24. For example, one or more of the auxiliary sensors 38 may include one or more pressure sensors forming a layer of the touch-enabled display 14 itself and may be, without limitation, piezoelectric pressure sensors, capacitive pressure sensors, piezoresistive strain gauges, optical pressure sensors, electromagnetic pressure sensors, etc. Other sensor examples include a pressure sensor, a motion sensor such as an accelerometer, gyroscope, cyclometer, or a magnetic sensor, an infrared (IR) sensor, an optical sensor, a speed and/or cadence sensor, an event-based sensor, a gesture sensor (e.g., for sensing gesture command). The sensor 38 thus may be implemented by one or more motion sensors, such as individual accelerometers, gyroscopes, and magnetometers and/or an inertial measurement unit (IMU) that typically includes a combination of accelerometers, gyroscopes, and magnetometers to determine the location and orientation of the AVD 12 in three dimension or by an event-based sensors such as event detection sensors (EDS). An EDS consistent with the present disclosure provides an output that indicates a change in light intensity sensed by at least one pixel of a light sensing array. For example, if the light sensed by a pixel is decreasing, the output of the EDS may be −1; if it is increasing, the output of the EDS may be a +1. No change in light intensity below a certain threshold may be indicated by an output binary signal of 0.

The AVD 12 may also include an over-the-air TV broadcast port 40 for receiving OTA TV broadcasts providing input to the processor 24. In addition to the foregoing, it is noted that the AVD 12 may also include an infrared (IR) transmitter and/or IR receiver and/or IR transceiver 42 such as an IR data association (IRDA) device. A battery (not shown) may be provided for powering the AVD 12, as may be a kinetic energy harvester that may turn kinetic energy into power to charge the battery and/or power the AVD 12. A graphics processing unit (GPU) 44 and field programmable gated array 46 also may be included. One or more haptics/vibration generators 47 may be provided for generating tactile signals that can be sensed by a person holding or in contact with the device. The haptics generators 47 may thus vibrate all or part of the AVD 12 using an electric motor connected to an off-center and/or off-balanced weight via the motor's rotatable shaft so that the shaft may rotate under control of the motor (which in turn may be controlled by a processor such as the processor 24) to create vibration of various frequencies and/or amplitudes as well as force simulations in various directions.

A light source such as a projector such as an infrared (IR) projector also may be included.

In addition to the AVD 12, the system 10 may include one or more other CE device types. In one example, a first CE device 48 may be a computer game console that can be used to send computer game audio and video to the AVD 12 via commands sent directly to the AVD 12 and/or through the below-described server while a second CE device 50 may include similar components as the first CE device 48. In the example shown, the second CE device 50 may be configured as a computer game controller manipulated by a player or a head-mounted display (HMD) worn by a player. The HMD may include a heads-up transparent or non-transparent display for respectively presenting AR/MR content or VR content (more generally, extended reality (XR) content). The HMD may be configured as a glasses-type display or as a bulkier VR-type display vended by computer game equipment manufacturers.

In the example shown, only two CE devices are shown, it being understood that fewer or greater devices may be used. A device herein may implement some or all of the components shown for the AVD 12. Any of the components shown in the following figures may incorporate some or all of the components shown in the case of the AVD 12.

Now in reference to the afore-mentioned at least one server 52, it includes at least one server processor 54, at least one tangible computer readable storage medium 56 such as disk-based or solid-state storage, and at least one network interface 58 that, under control of the server processor 54, allows for communication with the other illustrated devices over the network 22, and indeed may facilitate communication between servers and client devices in accordance with present principles. Note that the network interface 58 may be, e.g., a wired or wireless modem or router, Wi-Fi transceiver, or other appropriate interface such as, e.g., a wireless telephony transceiver.

Accordingly, in some embodiments the server 52 may be an Internet server or an entire server “farm” and may include and perform “cloud” functions such that the devices of the system 10 may access a “cloud” environment via the server 52 in example embodiments for, e.g., network gaming applications. Or the server 52 may be implemented by one or more game consoles or other computers in the same room as the other devices shown or nearby.

The components shown in the following figures may include some or all components shown in herein. Any user interfaces (UI) described herein may be consolidated and/or expanded, and UI elements may be mixed and matched between UIs.

Present principles may employ various machine learning models, including deep learning models. Machine learning models consistent with present principles may use various algorithms trained in ways that include supervised learning, unsupervised learning, semi-supervised learning, reinforcement learning, feature learning, self-learning, and other forms of learning. Examples of such algorithms, which can be implemented by computer circuitry, include one or more neural networks, such as a convolutional neural network (CNN), a recurrent neural network (RNN), and a type of RNN known as a long short-term memory (LSTM) network. Generative pre-trained transformers (GPTT) also may be used. Support vector machines (SVM) and Bayesian networks also may be considered to be examples of machine learning models. In addition to the types of networks set forth above, models herein may be implemented by classifiers.

As understood herein, performing machine learning may therefore involve accessing and then training a model on training data to enable the model to process further data to make inferences. An artificial neural network/artificial intelligence model trained through machine learning may thus include an input layer, an output layer, and multiple hidden layers in between that are configured and weighted to make inferences about an appropriate output.

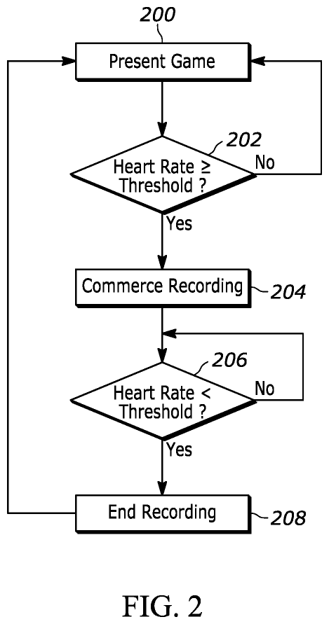

Refer now to FIG. 2. A computer simulation such as a computer game is presented on a display under control of a player manipulating a game controller. The game may be sourced from a game console and/or streaming server.

As the game is being played, the player may feel excitement in a particular spot of the game timeline. That excitement may be signaled automatically by a biometric signals such as hart rate/pulse rate, galvanic skin response, etc. and may be sensed by an appropriate sensor. State 202 indicates that should the biometric signal sch as heart rate meet or exceed a threshold rate the system may start recording the game at state 204. As the player plays the game, should the biometric signal such as heart rate recede by, for example, falling below a threshold at state 206, the recording may terminate at 208, having recorded a clip of the game characterized by increased player engagement as indicated by one or more biometric signals from the player.

Note that alternatively or in addition, clips may be recorded responsive to the player's biometric information indicating relaxation, e.g., during periods of low heart rate. In such examples the logic at state 202 simply determines whether heart rate is at or below a threshold. Heart rate may be inferred to detect when a player went to sleep, and this may be indicated onscreen or used to start recording a clip until the player wakes up again. Sleep periods may be indicated on the heat map discussed below.

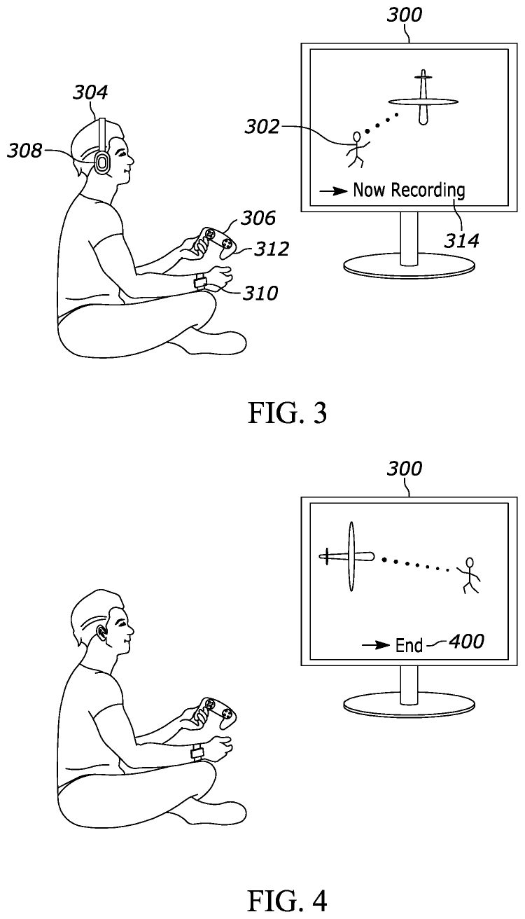

FIGS. 3 and 4 illustrate the case of using high heart rate to record a game clip automatically without player input (other than the biometric signal). A display 300 such as any display herein presents a computer game 302 under control of a player 304 manipulating a computer game controller 306. One or more biometric sensors may be engaged with the player 304, such as heart rate sensors, GSR sensors, pupil tracking sensors, and other types of biometric sensors that indicate excitement or lack thereof in the player.

In FIG. 3, multiple such sensors are shown. Specifically, a heart rate sensor 308 is shown mounted on an audio ear pad in contact with the player's ear. A heart rate sensor 310 may be mounted on a watch worn around the player's wrist. Yet again, heart rate/pulse sensors 312 may be implemented on the controller 306. When the biometric signal precipitates start of a recording of a game clip, an indication 314 of such may be presented on the display 300 as shown.

Likewise, when recording is terminated as at state 208 in FIG. 2, FIG. 4 illustrates that a notification of recording termination 400 may be presented in the display 30.

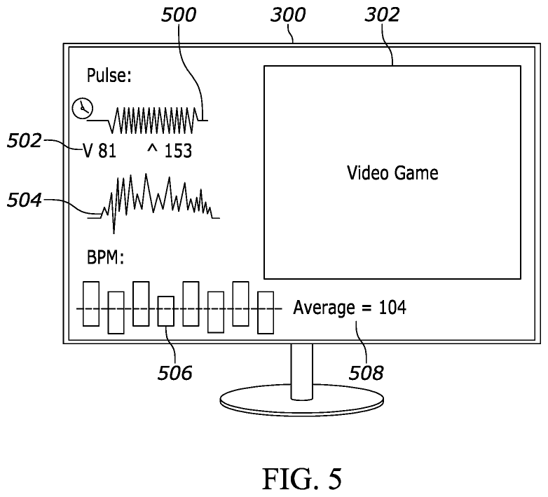

FIG. 5 illustrates additional display features that may be presented according to the biometric signals. A graph 500 of heart rate as sensed by the sensors may be presented on the display 300 adjacent the game presentation 302. Alpha-numeric indications 502 of low and high heart rates that were sensed may be presented. Further, a beats-per-minute line graph 504 may be presented based on the biometric signals. Yet again, a bar graph 506 representing discrete periods of time for discrete heart rates may be presented along with an indicator 508 of the average heart rate, for example.

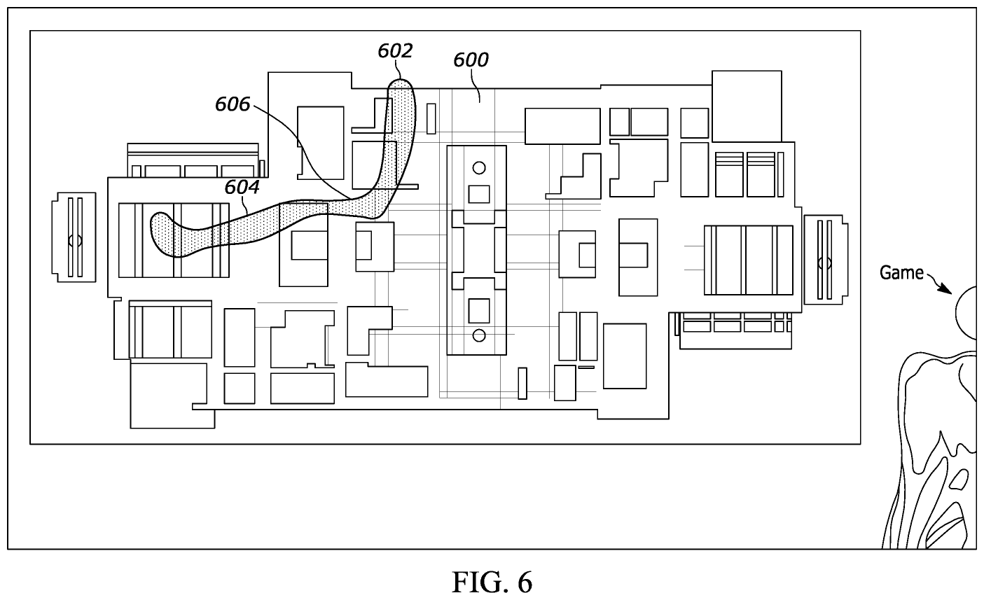

FIG. 6 illustrates a heat map 600 that can be presented on the display with or without being superimposed on the game. As shown in FIG. 6, the heat map includes a map 600 of the virtual space of the computer game. The movement of the player as represented by the player's character for example through the virtual space is tracked and correlated in time with the heart rate or other biometric signals received from the sensors engaged with the player to construct a travel path 602 of the player through the virtual space. The travel path may be color-coded or otherwise depicted according to the heart rate the player had as the player traversed segments of the path. Thus, for example, FIG. 6 shows first and second color segments 604, 606 corresponding to respective first and second heart rates (or heart rate ranges) of the player as the player traversed the virtual space.

If desired, the heat map can include more than just heart rate. For example, the heat map may include eye tracking and/or controller position data gathered from inward looking cameras on a HMD and motion sensors on a controller. When presented with or on the heat map, this can give developers insight when analyzing data from a play test perspective. Present principle facilitate observing this type of detail remotely.

Additionally, because biometric data from the player can be saved independently of the gameplay, a player or other person such as a spectator has the ability to toggle the replay to display none, some, or all of the data points and synchronize it with the gameplay footage as an overlay to, for example, improve user heads-up display/dashboard experience for the user experience team.

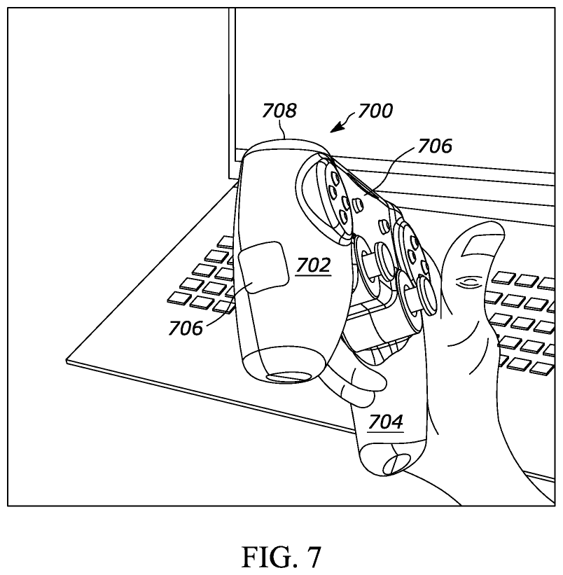

In non-limiting embodiments the player's heart rate may be sensed by sensors in a game controller. FIGS. 7-9 illustrate.

As shown in FIG. 7, a controller 700 with left and right handles 702, 704 and a bridge 706 therebetween may include an electrical component 706 such as an electro cardiogram (EKG) electrode on the outside of at least one of the handles and preferably on the outside of both handles where the player's palm rests when the player grips the controller to play the game, to provide a signal indicating pulse rate (and thus heart rate). Furthermore, one or more additional electrical components 708 may be provided at the distal end of one or both handles 702, 704 as shown, where the player's fingertips rest, to provide a signal representing a reference voltage.

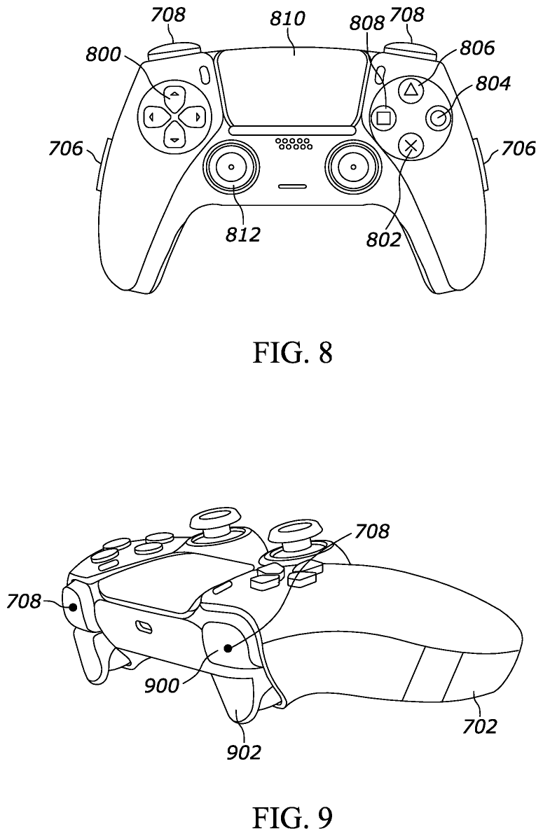

FIGS. 8 and 9 are provided to illustrate additional details of an example non-limiting controller 700, in this case embodied as a PlayStation® controller. The controller may include plural directional buttons 800 to navigate a screen cursor. The controller also may include a cross button 802, a circle button 804, a triangle button 806, and a square button 808. A touch pad 810 and left and right joysticks 812 also may be provided. As best shown in FIG. 9, one and in the non-limiting example shown two buttons 900, 902 are located adjacent respective respective distal ends of the left and right handles 702, 704 near the respective reference electrical components 708.

Signals from the electrodes shown in FIGS. 7-9 may be difficult to read when the player is moving his fingers, so appropriate signal processing such as convolutional filters and fast Fourier transforms may be used to filter out noise.

While the particular embodiments are herein shown and described in detail, it is to be understood that the subject matter which is encompassed by the present invention is limited only by the claims.

What is claimed is:

1. A method comprising:
identifying a heart rate of a computer gamer; and
responsive to the heart rate, automatically commencing recording a computer game being played by the gamer.

2. The method of claim 1, comprising:
commencing recording of the computer game responsive to the heart being at least as high as a first heart rate.

3. The method of claim 2, comprising:
ending recording of the computer game responsive to the heart rate being less than the first heart rate.

4. The method of claim 1, comprising presenting, on a display on which the computer game is presented, a heat map related to the heart rate.

5. The method of claim 4, wherein the heat map comprises a map of a virtual space.

6. The method of claim 5, wherein the map of the virtual space comprises a player's travel path through the virtual space.

7. The method of claim 6, wherein the travel path comprises first and second color segments corresponding to respective heart rates of the player as the player traversed the virtual space.

8. The method of claim 1, comprising identifying the heart rate based at least in part on at least one signal from at least first and second electrical components on a game controller, the first electrical component providing a reference voltage and the second electrical contact providing a pulse indication voltage.

9. The method of claim 8, wherein the first contact is adjacent a portion of the controller in contact with a finger of the player and the second contact is adjacent a palm of the player when the player holds the controller to control the game.

10. An apparatus comprising:
a computer game controller body (CGCB) comprising controls manipulable to send signals to control a computer game;
the CGCB comprising left and right handles grippable by left and right hands of a player and a bridge portion connecting the handles, each handle comprising a distal end;
a reference electrical component adjacent at least one of the distal ends to provide a reference voltage; and
a pulse electrical component medially located on at least one of the handles to provide a voltage representing a pulse in a palm of a player gripping the handle.

11. The apparatus of claim 10, comprising:
left and right reference electrical components adjacent respective distal ends of the respective left and right handles to provide a reference voltage; and
left and right pulse electrical components medially located on the respective left and right handles to provide a voltage representing a pulse.

12. The apparatus of claim 10, wherein the controls comprise:
plural directional buttons;
a cross button, a circle button, a triangle button, and a square button; and
at least one respective button adjacent the respective distal ends of the left and right handles.

13. A device comprising:
at least one processor system configured to:
receive at least one signal from at least one pulse rate sensor; and
responsive to the signal, commence recording of at least one computer simulation.

14. The device of claim 13, wherein the computer simulation comprises a computer game.

15. The device of claim 14, wherein the processor assembly is configured to:
commence recording of the computer game responsive to the pulse being at least as high as a first rate.

16. The device of claim 15, wherein the processor assembly is configured to:
end recording of the computer game responsive to the pulse rate being less than the first rate.

17. The device of claim 14, wherein the processor assembly is configured to:
present, on a display on which the computer simulation is presented, a heat map related to the pulse rate.

18. The device of claim 17, wherein the heat map comprises a map of a virtual space.

19. The device of claim 18, wherein the map of the virtual space comprises a player's travel path through the virtual space.

20. The device of claim 19, wherein the travel path comprises first and second color segments corresponding to respective pulse rates of the player as the player traversed the virtual space.
